(19) United States
(12) Patent Application Publication
(10) Pub. No.: US 2010/0199290 A1
(43) Pub. Date: Aug. 5, 2010

(54) SYSTEM AND METHOD FOR MULTIFUNCTION DEVICE ENUMERATION

(76) Inventor: Richard Thomas Kavanaugh, Encinitas, CA (US)

Correspondence Address: Nixon Peabody LLP, P.O. Box 60610, Palo Alto, CA, 94306, US

(21) Appl. No.: 12/413,500

(22) Filed: Mar. 27, 2009

Related U.S. Application Data
(60) Provisional application No. 61/149,283, filed on Feb. 2, 2009.

(51) Int. Cl. G06F 9/54

(52) U.S. Cl. 719/327

(57) ABSTRACT

Disclosed are systems and methods for controlling the enumeration of a multifunction peripheral device on a host computer. A multifunction peripheral device may include a generic and non-generic functional units connected to a host interface. The device may store in its non-volatile memory one or more drivers for the non-generic functional unit. The peripheral device may further include a controller for controlling the order in which the generic and non-generic functional units are exposed to and enumerated on the host system. The controller may include a switch operable to switch on and off the generic and non-generic functional units thereby controlling the order in which these units are exposed to and enumerated on the host system.

### CROSS-REFERENCE TO RELATED APPLICATIONS

This application claims priority to U.S. Provisional Application Ser. No. 61/149,283, filed Feb. 2, 2009.

### TECHNICAL FIELD

This present disclosure relates to the field of computer systems and, more specifically, to the system and methods for enumerating various functional units of multifunction peripheral or embedded devices on a host computer system.

### BACKGROUND

Multifunction peripheral and embedded devices are becoming increasingly popular as device manufacturers look to add value and additional capabilities to their products by adding various functional units to the peripheral devices. Many of these multifunction devices expose their various functional units through a single physical interface that supports the ability for a descriptor or configuration table to be read out of the device by the host computer during device enumeration. Some examples of device interfaces with these capabilities include USB and Fire Wire (IEEE 1394).

The descriptor or configuration table of a peripheral device typically contains the necessary information for the host computer to determine which drivers must be loaded to enumerate, expose and control each functional unit of the peripheral device. Typically, non-generic functional units of a device require a unique set of vendor specific and/or host operating system (OS) native drivers, share drivers with one or more other functions of the same parent multifunction device, or a combination of the two.

When these multifunction devices are enumerated in a host computer they are typically configured to enumerate each of the functional units of the device simultaneously. However, it may be at times desired to only expose one or more of the functional units of a device, but not all of the functional units, to a host computer. Accordingly, there is a need for a mechanism to control the order in which functional units of a multifunction device are exposed to and enumerated on a host computer.

### OVERVIEW

Disclosed are systems and methods for controlling the enumeration of a multifunction peripheral device on a host computer. In one example embodiment, a multifunction peripheral device may include a generic and non-generic functional units connected to a host interface. The device may store in its non-volatile memory one or more drivers for the non-generic functional unit. The peripheral device may further include a controller for controlling the order in which the generic and non-generic functional units are exposed to and enumerated on the host computer. The controller may include a switch operable to switch on and off the generic and non-generic functional units thereby controlling the order in which these units are exposed and enumerated. The switch may include an automated switch or a manually operated switch.

In one example embodiment, a method for enumerating on a host computer a multifunction peripheral device having a generic functional unit and non-generic functional unit includes connecting the peripheral device to the host system. The method further includes exposing to and enumerating on the host computer the generic functional unit of the peripheral device. Then, locating a driver for the non-generic functional unit of the peripheral device. The method further includes exposing to and enumerating on the host computer a non-generic functional unit. In one example embodiment, exposing of the generic functional unit includes switching off the non-generic functional unit of the peripheral device. In another example embodiment, exposing of the non-generic functional unit includes switching off the generic functional unit of the peripheral device.

In another example embodiment, a method for enumerating on a host computer a multifunction peripheral device having a generic functional unit and non-generic functional unit includes switching off the non-generic functional unit of the peripheral device and switching on the generic functional unit of the peripheral device. The method further includes enumerating the generic functional unit on the host computer and loading on the host computer a driver for the non-generic functional unit. The method further includes switching on the non-generic functional unit of the peripheral device and enumerating the non-generic functional unit on the host system. In one example embodiment, the enumeration of the non-generic functional unit includes resetting and re-enumerating the generic functional unit of the peripheral device.

In another example embodiment, a method for enumerating on a host computer a multifunction peripheral device having a generic functional unit and non-generic functional unit includes exposing to and enumerating on the host computer the generic functional unit of the peripheral device. The method further includes providing to the host system a thin driver operable to locate and load on the host system a device driver for the non-generic functional unit of the peripheral device. The method further includes exposing to and enumeration on the host system a non-generic functional unit. The method further includes installing the driver for the non-generic functional unit.

Yet in another example embodiment, a method for enumerating on a host system a multifunction peripheral device having a generic functional unit and non-generic functional unit includes detecting the exposed generic functional unit of the connected peripheral device and enumerating the detected generic functional unit. The method further includes loading a thin driver operable to locate and load on the host system a device driver for the non-generic functional unit of the peripheral device. The method further includes detecting the exposed non-generic functional unit of the connected device and enumerating the same on the host computer. The method further includes installing the device driver for the enumerated non-generic functional unit.

The disclosed systems and methods enable the multifunction peripheral devices to determine if all required device drivers are present in the system memory of the host computer before the device determines whether or not to expose the non-generic functional units during the initial device enumeration process, thus reducing the time required to initialize the peripheral device after it is connected to the host computer and therefore improving the overall device enumeration user experience. Other advantages of the present invention will be apparent to those of skill in the art from the accompanied drawings and the following detailed description of example embodiments.

### BRIEF DESCRIPTION OF THE DRAWINGS

The invention may be best understood by referring to the following description and accompanying drawings that are used to illustrate embodiments of the invention.

In the drawings:

FIG. 1 is a diagram of one example embodiment of a host computer system.

FIG. 2 is a diagram of one example embodiment of a peripheral device.

FIGS. 3A-C are diagrams of example embodiments of the switching mechanism.

FIGS. 4-6 are flow diagrams of example embodiments of the enumeration process.

### DETAILED DESCRIPTION OF EXAMPLE EMBODIMENTS

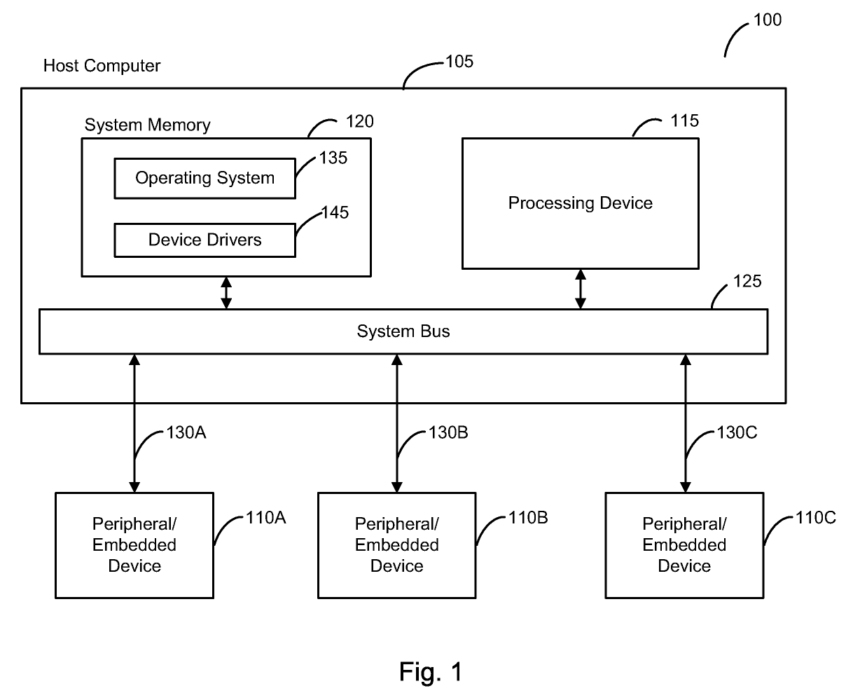

One example embodiment of a computer system 100 shown in FIG. 1 includes a host computer 105 and a plurality of multifunction peripheral or embedded devices 110A, 110B, 110C. The host computer 105 may include, but is not limited to, a desktop computer, a server computer, a mobile computer, a personal digital assistant (PDA), a cellular phone, a network router, a wireless access point, a gaming console or other type of data processing device. The one or more devices 110A, 110B, 110C may include, but are not limited to, an internal or external modems, printers, memory devices, such as disk and Flash drives, scanners, microphones, speakers, cameras, PCI Express cards, and the other types of devices that expand functionality of the host computer 105.

In one example embodiment, the host computer 105 may include a processing device 115, a system memory 120 and system bus 125, which interconnects the processing device 115 with the system memory 120. The system bus 125 may include, but is not limited to a 16 bit, 32 bit, 64 bit or other type of parallel connector. The host computer 105 may further include one or more input/output buses 130A, 130B, 130C that interconnect the host computer 105 with its peripheral devices 110A, 110B, 110C. The I/O buses may include but are not limited to a PCI, PCI Express, USB, ISA, AGP, Serial ATA, Ethernet, IEEE 1394 and other type of communication interface.

The processing device 115 of the computer 105 is configured to interpret various computer programs, run application, and direct data and instructions to and from other devices, like the system memory 120 and peripheral/embedded devices 110A, 110B, 110C. In one example embodiment, the processing device 115 may include a general purpose processor, such as an Intel® Dual-Core™ or Pentium processors, an AMD Turion™ 64 processor or other types of microprocessors. In another example embodiment, the processing device 115 may include application specific integrated circuit (ASIC), field programmable gate arrays (FPGAs), programmable logic device (PLD) and other types of custom designed circuits.

System memory 120 may include, but is not limited to a random access memory (RAM), a read only memory (ROM), a programmable ROM (PROM), an erasable PROM (EPROM), a FLASH-EPROM and other types of dynamic, volatile and nonvolatile information storage medium. In one example embodiment, system memory 120 may store an operating system (OS) 135, such as Windows Vista®, Unix, Linux or other type of OS. System memory 120 may also store one or more device drivers 145, which include program subroutines that allow host computer 105 to communicate with one or more functional units of peripheral or embedded devices 110A, 110B, 110C or other devices that may be connected to the host computer 105.

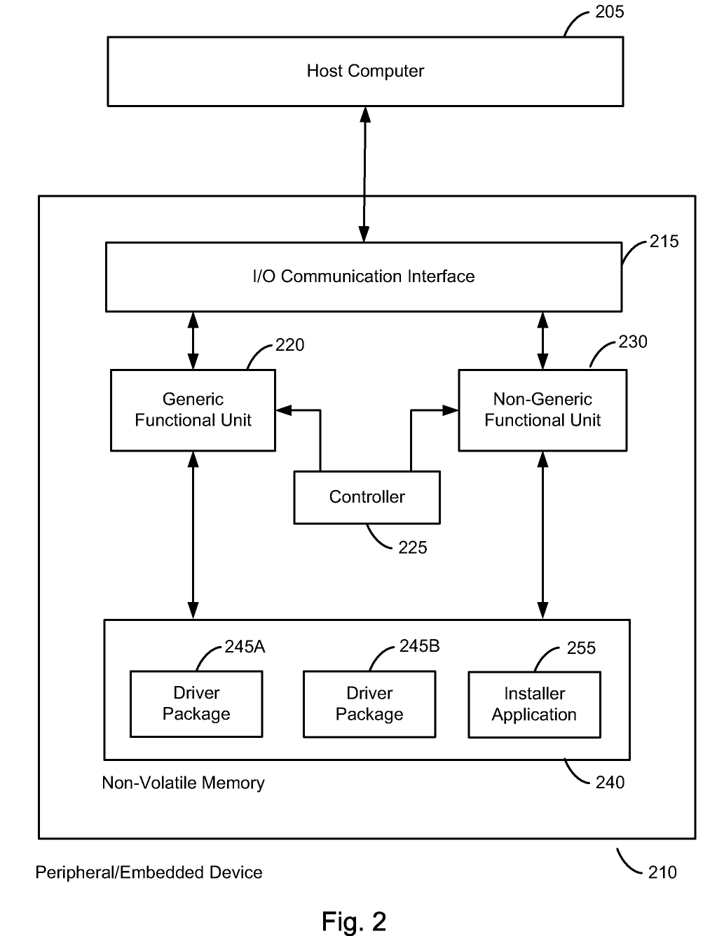

One example embodiment of a multifunction peripheral device 210 is depicted in FIG. 2. The term peripheral as used herein also includes devices embedded in a host computer system. The device 210 may include an I/O communication interface 215, such as PCI, PCI Express, USB, ISA, AGP, Serial ATA, Ethernet, IEEE 1394 or other type of wired or wireless interface for communicating with a corresponding I/O bus of the host 205. The multifunction device 210 may include several functional units, such as generic functional units 220 and non-generic functional units 230. The generic functional units 220 are typically those that are natively supported by the OS of the host computer 205. Such generic functional units may include mass storage, input/output, audio/video and other functions. The non-generic functional units 230 provide vendor-specific functions that are not natively supported by the OS of the host computer 205, such as optical scanning, gaming functions, TV tuning and other functions.

In one example embodiment, the multifunction peripheral device may include memory 240, such as a RAM, ROM, PROM, EPROM, FLASH-EPROM and other types of dynamic, volatile and nonvolatile information storage medium. In one example embodiment, memory 240 may be shared by the functional units 220 and 230. Alternatively, each functional unit may have its own dedicated portion of memory 240. In one example embodiment, the memory 240 may be used to store, inter alia, device drivers 245A and 245B and installer application 255. Device drivers 245A and 245B include program subroutines that allow host computer 205 to communicate with one or more functional units of the device 210. The installer application 255 enables installation of the device drivers 245A and 245B on the host computer system.

In one example embodiment, device drivers 245A may be associated with the generic functional unit 220 and device drivers 245B may be associated with the non-generic functional unit 230. For example, an add-on sound card that implements audio and game-port capabilities may appear as two independent devices to the host 205. In one example embodiment, the generic audio functionality provided by the functional unit 220 may be serviced by audio drivers 245A. Alternatively, the generic audio functionality may be natively supported by the host computer 205 with native drivers 145 stored in the host computer memory 120. The non-generic gaming functionality provided by the functional unit 230 may be serviced by a game-port drivers 245B.

In another example embodiment, both drivers 245A and 245B may be associated with the non-generic functional unit 230. For instance, non-generic functional unit 230 may require several OS-specific drivers that allow the device 210 to communicate with host computers 205 running different operating systems. For example, driver 245A may provide program subroutines that allow the non-generic functional unit 230 to operate with a host computer 205 that runs Microsoft Windows® operating system and driver 245B may provide program subroutines that allow the non-generic functional unit 230 to operate with a host computer 205 that runs Mac OS, Unix or other operating systems. Those of skill in the art will recognize that there are other instances when a functional unit may require several different drivers.

When a multifunction peripheral or embedded device 210 is first connected to the host computer 205, the operating system of the host computer 205 typically tries to enumerate all separate functional units of the connected device. During the enumeration process, OS 135 may identify one or more functional units of the connected device, load the corresponding device drivers, allocate the required system resources and perform other device initialization services. For generic functional units 220, OS 135 may load native drivers 145, which are typically stored in system memory 120 of the host computer 205. For non-generic functional units 230, OS 135 may load vendor-specific drivers 245A and 245B, which may be provided by non-generic functional unit 230, may be obtained from an installation CD or downloaded via the Internet from the device manufacturer's servers.

During installation of drivers on the host computer 205, a generic functional unit 220 may sometimes automatically install vendor-specific or non-OS native drivers for one or more non-generic functional units 230. One example is a generic USB mass storage functional unit that typically exposes an installer application 255 that, when executed on the host computer 205, may pre-load the necessary drivers for some non-generic functional units 230. In some instances, however, the device 210 may not have the capability to support one or more non-generic functional units 230 when these units are exposed during installation of the generic functional units. This may cause a fatal exception, performance issues, and/or an undesired user experience. In this case, it would be desirable to suppress the enumeration of some non-generic functional units while still enumerating the other functions of the multifunction device 210.

To that end, in one example embodiment, the multifunction device 210 may include a functional unit controller 225, which controls operation of various functional units. More specifically, the controller 225 may control enumeration of functional units 220 and 230 on the host computer 205. For example, controller 225 may control the order in which device interface descriptors or configuration tables are exposed to the host 205 during device enumeration process. In one example embodiment, controller 225 may include, but is not limited to, a general purpose processor, application specific integrated circuit (ASIC), field programmable gate arrays (FPGAs), programmable logic device (PLD) and other type of software- or hardware-implemented control logic.

In one example embodiment, the controller 225 may include a functional unit switching mechanism, which may be implemented as a 2-way, 3-way or N-way switch, where N depends on the number of functional units of device 210 and the combination in which these units may be operated. In one example embodiment, the switching mechanism may be operative to select one or more predefined device interface descriptor or configuration tables to be exposed to the host 205 during the device enumeration process. In another example embodiment, the switching mechanism may be operative to select one or more of the attributes of the exposed functional unit that are reported to the host 205 through the device interface descriptor or configuration table.

The switching mechanism may be implemented in several different ways. In one example embodiment, the switching mechanism may be implemented as a physical switch accessible to the user, so that the user could toggle the switch to select functional units to be enumerated on the host 205 through the single device interface 215. In another example embodiment, the switching mechanism may be implemented in software as a part of the device installation program, so that the user can select through a GUI one or more functional units to be enumerated on the host 205 during device installation. Yet in another example embodiment, the switching mechanism may be driven from the host 205 as will be described herein. Those skilled in the art may recognize that there are other ways for implementing the switching mechanism for multifunction device 210.

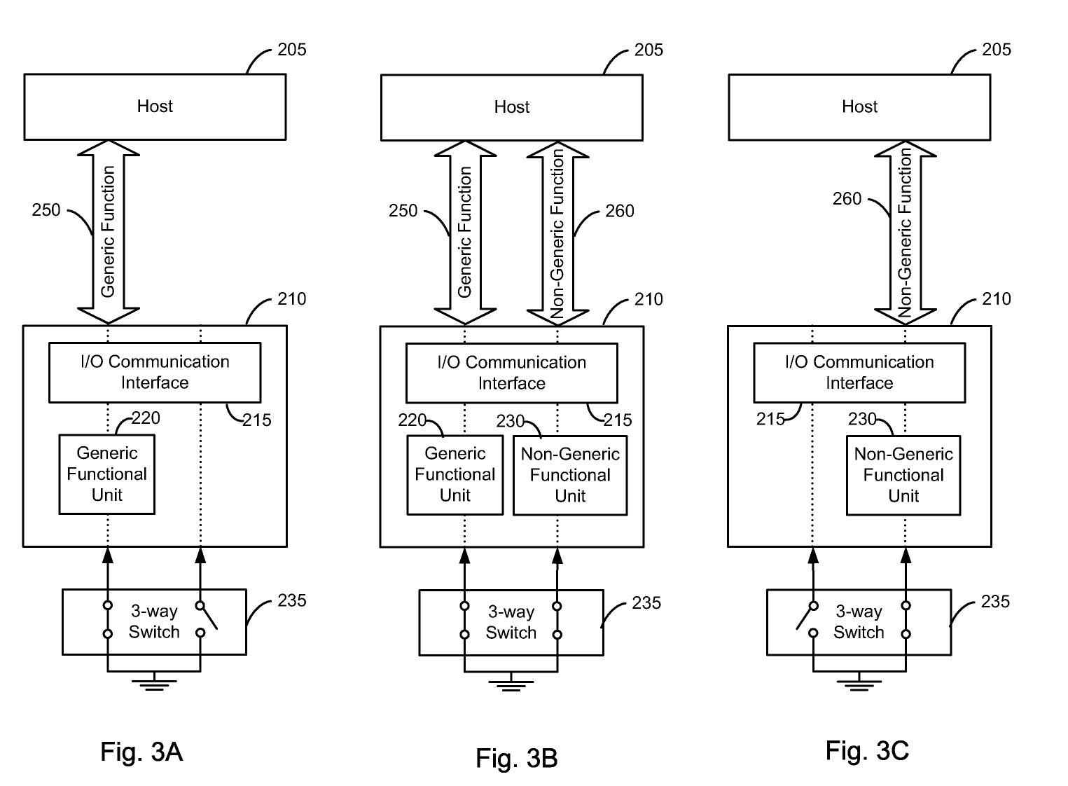

FIGS. 3A, 3B and 3C depict several example embodiments of a device enumeration process using the switching mechanism described above. The switching mechanism may be implemented as a physical (or software-based) 3-way switch 235. The switch may be exposed on the outside of the device 210 and is available for the user to toggle through a physical or software-based graphical user interface. The current toggle states of the switch 235 are inputs to the multifunction device 210 through an interface, such as a General Purpose I/O (GPIO) signal (not shown). Each possible switch setting option may trigger the device 210 to expose a different descriptor or configuration table to the host computer 205 during the device enumeration process.

In FIG. 3A, the user may toggle switch 235 to trigger the controller 225 to only expose to host 205 the generic functional unit 220, such as a mass storage functional unit. In response, the controller 225 may run on host 205 installation program 255, which installs the generic functional unit 220 using device drivers 145 from system memory 120. During device installation, the generic functional unit 220 is enumerated on the host 205. In addition, installation program 255 may retrieve from device memory 240 various driver packages 245A and/or 245B for non-generic functional unit 230 and pre-load them into system memory 120. If the necessary drivers are not available on the device 210, the installation program may prompt the user to specify another location where the drivers may be loaded from, such as an installation CD or device manufacturer's website. Afterwards, only generic functions of the device 210 are available for the host 205 as represented by the bus 250, symbolic of information exchange between the host 205 and the device 210.

Next, the user may toggle switch 235 to trigger the multifunction device 210 to expose a different device configuration to host 205. For example, the switch may be toggled to exposes both the generic functional unit 220 and the non-generic functional unit 230, as shown in FIG. 3B. The device 210 may need to re-enumerate with host 205 to allow the new device configuration to be read by the host. This can be done manually by the user or automatically by the device 210 through an internal reset operation when a switch position change is detected. After the host 205 reads the new configuration from the device 210, the host enumerates the non-generic functional unit 230 and installs the necessary drivers that were pre-loaded during enumeration of the generic functional unit 220. Afterwards, both functions of the device 210 are available for the host 205 as represented by buses 250 and 260, symbolic of information exchange between the host 205 and the device 210.

In another example embodiment, the user may toggle switch 235 to trigger the multifunction device 210 to expose only one or more non-generic functional units 230, but to hide the generic functional unit 220, as shown in FIG. 3C. This may be desired, if for example, the host 205, device 210, and/or drivers associated with the generic functional unit 220 are implemented in such a way that when the generic functional unit 220 is enumerated, the overall power consumption of the host 205 is adversely impacted. If the user is aware of this and does not have a current need for the generic functional unit 220, the user can toggle the switch 235 to hide the generic unit. Of course there are other reasons known to those skilled in the art for switching off one or more functional units of device 210 during or after enumeration with host computer 205. For example, this switch configuration may be used when device drivers for the non-generic functional unit are available in the memory of the device 210 and may be directly loaded and installed by the OS of the host computer 205 during initial device installation. Afterwards, only the non-generic functions of the device 210 are available for the host 205 as represented by the bus 260, symbolic of information exchange between the host 205 and the device 210.

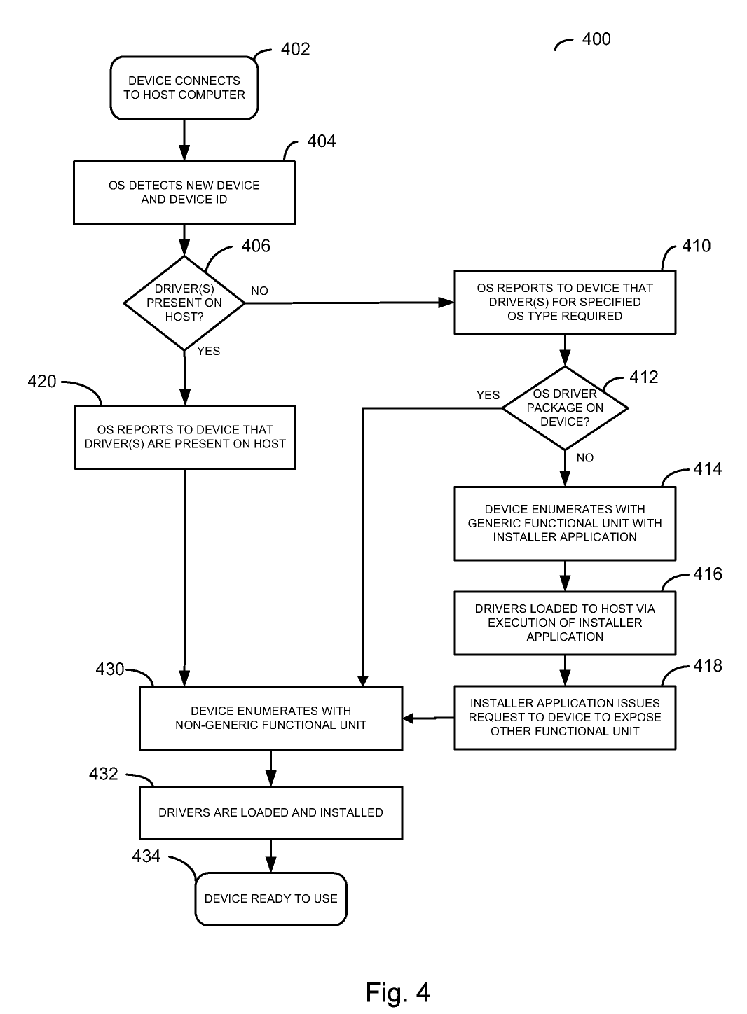

FIG. 4 depicts one example embodiment of the enumeration process of the multifunction peripheral (or embedded) device using the switching mechanism described above. Process 400 begins at step 402 with the device being connected to the host computer. At step 404, the host OS detects the new multifunction device and determines device ID. At step 406, the OS determines if the necessary device drivers are present in the system memory of the host computer. If the device has not been previously enumerated with the generic functional unit and/or the non-generic functional units are switched off, as shown in FIG. 3A, the non-generic functional unit drivers are not present on the host and the OS reports to the device that specific device drivers are required, step 410. If the necessary device drivers are present on the device or the host, step 412 or step 420, the non-generic functional unit(s) may enumerate with the host computer, step 430. The necessary device drivers are loaded and installed on the host computer, step 432. The non-generic functional unit(s) of multifunction device is then ready for use, step 434.

However, if the non-generic device drivers are not found on the device, step 412, the device may enumerate using its generic functional unit, such as mass storage unit, using native device drivers stored in the host system memory, step 414. Once the generic functional unit is enumerated, the generic functional unit may run an installer application on the host to enumerate the non-generic functional units of the device, step 416. Specifically, the installer application may locate or prompt the user to locate the necessary non-generic device drivers. Once the non-generic device drivers are located and loaded into the host system memory, the installer application may issue request to the device to expose its non-generic functional unit(s), step 418. The non-generic functional unit(s) are then enumerated, step 430, necessary drivers are installed, step 432, and all non-generic functional unit(s) of the device are ready for use, step 434.

In one example embodiment, the multifunction peripheral (or embedded) device may use a “thin” driver to enable the host computer to control initial device enumeration. More specifically, the thin driver may enable the operating system of the host computer to communicate indirectly with the device in order to control enumeration of generic and non-generic functional units. The thin driver may communicate with the multifunction device via I/O bus standardized messaging, I/O bus vendor specific messaging, via vendor specific extensions, messaging encapsulated in data payloads of I/O bus standardized messaging, or other methods known to those skilled in the art.

In one example embodiment, the thin driver may be implemented as an upper or lower level filter driver for one of the drivers in the native mass storage driver stack for the Microsoft Windows® operating system or a standalone mass storage device driver that is configured to replace or supersede the native mass storage device driver for a specific set of devices from the standard mass storage device class. Those skilled in the art may recognize that the thin driver may be implemented differently in other embodiments.

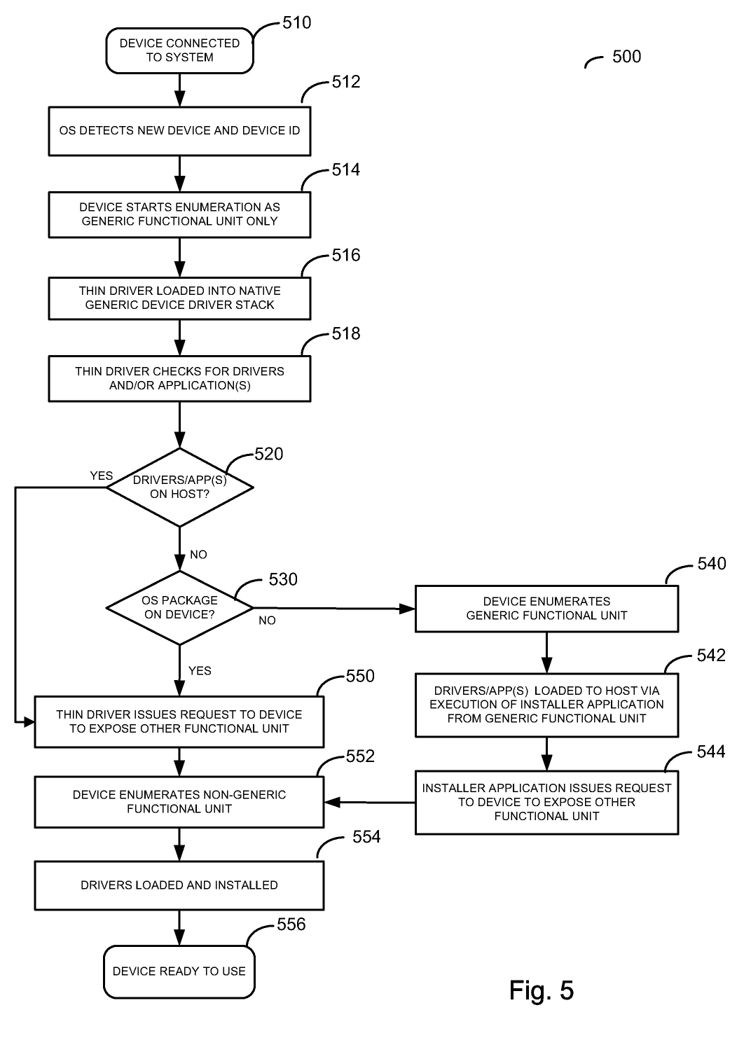

FIG. 5 depicts another example embodiment of the enumeration process of the multifunction peripheral (or embedded) device with thin drivers. The enumeration process 500 begins at step 510 with the device being connected to the host computer for the first time with the non-generic functional units switched off, as show in FIG. 3A. At step 512, the OS of the host computer detects the new multifunction device and determines the device ID. Since all non-generic functional units are switched off, the device enumerates with its generic functional unit only, step 514. During enumeration, the device may load a thin driver on the host computer, step 516. The thin driver may first determine whether non-generic device drivers and/or application components are present in the system memory of the host computer, step 518. If no necessary drivers are present on the host, step 520, the thin driver may check whether such drivers are present on the device, step 530. If the necessary drivers are found either on the host or on the device, the thin driver may issue a request to the device to expose its non-generic functional unit(s), step 550. The device then enumerates on the host computer with non-generic functional unit(s), step 552. The necessary device drivers are loaded and installed on the host computer, step 554. The non-generic functional unit(s) of the multifunction device is then ready to use, step 556.

However, if the non-generic device drivers are not found, steps 520 and 530, the device may enumerate using its generic functional unit, such as the mass storage unit, using native device drivers stored in the host system memory, step 540. Once the generic functional unit is enumerated, the generic functional unit may run an installer application on the host to enumerate the non-generic functional units of the device, step 542. Specifically, the installer application may locate or prompt the user to locate the necessary non-generic device drivers. Once the non-generic device drivers are located and loaded into the host system memory, the installer application may issue a request to the device to expose its non-generic functional unit(s), step 544. The non-generic functional unit(s) are then enumerated, step 552, necessary drivers are installed, step 554, and all non-generic functional unit(s) of the device are ready for use, step 556.

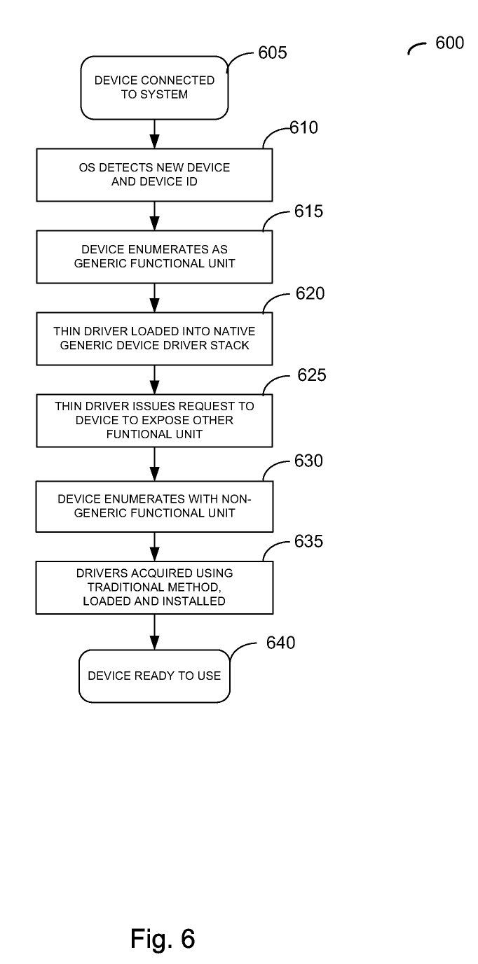

FIG. 6 depicts another example embodiment of the enumeration process of the multifunction peripheral (or embedded) device using the switching mechanism described above and thin drivers. The process 600 may be used during initial device enumeration when all functional units of the multifunction device are switched on, as shown in FIG. 3B. The process 600 may also be used if the host operating system does not support an installer package present in the memory of the generic functional unit. The thin driver would serve the operating system and host computer by preventing the device from enumerating with only the generic functional unit, which would be of no use to such an operating system, and therefore also prevent the device from exposing the non-generic functional unit(s) whose drivers and application components will be loaded onto the host computer through other traditional or non-traditional means.

As depicted, at step 605, the device is connected to the host computer for the first time with all generic functional units switched on. At step 610, the OS of the host computer detects the new multifunction device and determines the device ID. Since all non-generic functional units are switched on, the device begins enumeration of all functional units beginning with generic functional unit, step 615. During enumeration, the device may load a thin driver into the native generic device driver stack on the host computer, step 620. The thin driver may issue a request to the device to expose its non-generic functional unit(s), step 625. The device then enumerates on the host computer with the non-generic functional unit(s), step 630. The necessary device drivers are acquired from the installation CD or the Internet, loaded and installed on the host computer, step 635. The non-generic functional unit(s) of the multifunction device is then ready for use, step 640.

In one example embodiment, the thin driver for a particular operating system may be installed by an installer package present in the memory of the generic memory storage functional unit of the peripheral device. This installer package may or may not contain the necessary driver and application components for the same operating system required for the non-generic functional unit. If the installer package contains the necessary drivers, the thin driver may be used to assist the device to determine how to initially enumerate, as shown in process 500. If the installer package does not have the necessary drivers, the thin driver, once loaded and installed, may be used to request the device to connect the non-generic function unit(s), as shown in process 600.

In another example embodiment, the thin driver for a particular operating system may be part of the operating system and thus loading of the thin driver to the system memory of the host computer may not be independently required. In yet another example embodiment, the thin driver may be installed through a more traditional method, such as an installation CD or the Internet. Those of ordinary skill in the art may appreciate that there are other ways to implement loading and installation of a thin driver.

Those of ordinary skill in the art will appreciate that the disclosed example embodiments of systems and methods provide an efficient way for a host computer to determine with or without help of the user if and when to enumerate various functional units of a multifunction device that reduces the time required to enumerate the device to a steady and useable set of functional connections, improves the overall self component installation user experience, and reduces the risk of special case handling failures in the operating system for a peripheral or embedded device that enumerates with different sets of functional units over a short period of time.

Furthermore, it may be appreciated that the disclosed systems and methods allow a peripheral device to determine, with help from the host and or user, if it should enumerate initially as either only a generic (native) device (e.g., mass storage device) or also allow the enumeration of its non-generic (proprietary) functional unit based on whether or not the host computer system already had the necessary device drivers for the non-generic function of the device and whether or not the device already included a driver installation package for the current operating system of the host in the memory of the generic memory storage function of the device. This capability may reduce the procedural steps and time required for subsequent enumerations of the device after the drivers for the device are already installed, thus improving the device enumeration user experience. This capability may also prevent a device from being enumerated as only a memory storage device on host computer systems executing an operating system for which there was no installer package for the operating system in the device thus reducing frustration by users of these types of operating systems.

In one example embodiment, the capability of locating device drivers in the system memory of the host computer may be extended to support checking for application components associated with the peripheral device that may also be available in the non-volatile memory of the generic memory storage functional unit of the device. In another example embodiment, the capability of checking for drivers and application components may be extended to check for the storage of specific minimum versions of these components in the case that one or more components already present in the system memory of the host computer are outdated and require an upgrade before the host computer can fully utilize the non-generic functional unit of the device.

In the interest of clarity, not all features of the implementations of the peripheral device enumeration mechanism are shown and described. It will, of course, be appreciated that in the development of any such actual implementation of the device enumeration processes, numerous implementation-specific decisions must be made in order to achieve the developer's specific goals, such as compliance with application-, system-, device- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of computer systems having the benefit of this disclosure.

In accordance with this disclosure, the components, process steps, and/or data structures described herein may be implemented using various types of operating systems, computing platforms, peripheral or embedded devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium.

Further more, it should be noted that systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or other means suitable for the purposes described herein.

Those of ordinary skill in the art will realize that the description of the system and methods for multifunction device enumeration are illustrative only and are not intended to be in any way limiting. Other embodiments will readily suggest themselves to those of ordinary skill in the art having the benefit of this disclosure. Further more, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A method for enumerating on a host system a multifunction peripheral device having a generic functional unit and non-generic functional unit, the method comprising:
connecting the peripheral device to the host system;
exposing to the host system the generic functional unit of the peripheral device;
enumerating the exposed generic functional unit on the host system;
locating a driver for the non-generic functional unit of the peripheral device;
exposing to the host system a non-generic functional unit; and
enumerating the exposed non-generic functional unit on the host system.

2. The method of claim 1, wherein exposing the generic functional unit includes switching off the non-generic functional unit of the peripheral device.

3. The method of claim 2, wherein exposing the non-generic functional unit includes switching off the generic functional unit of the peripheral device.

4. The method of claim 2, wherein exposing the non-generic functional unit includes switching on the generic functional unit and switching on the non-generic functional unit.

5. The method of claim 3, wherein enumerating the generic functional unit includes uploading to the host system a thin driver configured to locate the driver for the non-generic functional unit of the peripheral device.

6. The method of claim 5, wherein the location of the driver includes one of the memory of the host system, memory of the peripheral device, installation CD and a network server.

7. The method of claim 6, further comprising installing on the host system the driver for the non-generic functional unit.

8. The method of claim 1, wherein the generic functional unit and non-generic functional unit are being connected to the host system through a single interface.

9. The method of claim 8, wherein the interface includes one of a wired interface and wireless interface.

10. A method for enumerating on a host system a multifunction peripheral device having a generic functional unit and non-generic functional unit, the method comprising:
switching off the non-generic functional unit of the peripheral device;
switching on the generic functional unit of the peripheral device;
enumerating the generic functional unit on the host system;
loading on the host system a driver for the non-generic functional unit;
switching on the non-generic functional unit of the peripheral device; and
enumerating the non-generic functional unit on the host system.

11. The method of claim 10, wherein enumerating the non-generic functional unit includes resetting and re-enumerating the generic functional unit of the peripheral device.

12. The method of claim 11, wherein enumerating the generic functional unit includes uploading to the host system a thin driver operable to locate the driver for the non-generic functional unit of the peripheral device.

13. The method of claim 12, wherein the location of the driver includes one of the memory of the host system, memory of the peripheral device, installation CD and a network server.

14. The method of claim 13, further comprising installing on the host system the driver for the non-generic functional unit.

15. The method of claim 10, wherein the generic functional unit and non-generic functional unit are being connected to the host system through a single interface.

16. The method of claim 15, wherein the interface includes one of a wired interface and wireless interface.

17. A method for enumerating on a host system a multifunction peripheral device having a generic functional unit and non-generic functional unit, the method comprising:
exposing to the host system the generic functional unit of the peripheral device;
enumerating the exposed generic functional unit on the host system;
providing to the host system a thin driver operable to locate and load on the host system a device driver for the non-generic functional unit of the peripheral device;
exposing to the host system a non-generic functional unit;
enumerating the exposed non-generic functional unit on the host system; and
installing on the host system the driver for the non-generic functional unit.

18. The method of claim 17, wherein exposing the generic functional unit includes switching off the non-generic functional unit of the peripheral device.

19. The method of claim 18, wherein exposing the non-generic functional unit includes switching off the generic functional unit of the peripheral device.

20. The method of claim 17, wherein exposing the non-generic functional unit includes switching on the generic functional unit and non-generic functional unit.

21. The method of claim 17, wherein the location of the driver includes one of the memory of the host system, memory of the peripheral device, installation CD and a network server.

22. The method of claim 17, wherein the generic functional unit and non-generic functional unit are connected to the host system through a single interface.

23. The method of claim 22, wherein the interface includes one of a wired interface and wireless interface.

24. A method for enumerating on a host system a multifunction peripheral device having a generic functional unit and non-generic functional unit, the method comprising:
detecting the exposed generic functional unit of the connected peripheral device;
enumerating the detected generic functional unit of the peripheral device;
loading a thin driver operable to locate and load on the host system a device driver for the non-generic functional unit of the peripheral device;
detecting the exposed non-generic functional unit of the connected device; and
enumerating the detected non-generic functional unit of the peripheral device.

25. The method of claim 24, further comprising installing the device driver for the non-generic functional unit.

26. The method of claim 25, wherein the location of the device driver includes one of the memory of the host system, memory of the peripheral device, installation CD and a network server.

27. The method of claim 26, wherein the generic functional unit and non-generic functional unit are connected to the host system through a single interface.

28. The method of claim 27, wherein the interface includes one of a wired interface and wireless interface.

29. A multifunction peripheral device comprising:
a host interface for communicating with a host system;
a first functional unit connected to the host interface;
a second functional unit connected to the host interface;
a non-volatile memory for storing one or more device drivers for at least one of the first functional unit and the second functional unit; and
a controller for controlling the order in which the first functional unit and second functional unit are exposed to and enumerated on the host system.

30. The device of claim 29, wherein the controller includes a switch operable to switch on and off the first and second functional units of the device thereby controlling the order in which the functional units are exposed to and enumerated on the host system.

31. The device of claim 30, wherein the switch includes one of an automated switch and a manual switch operated by a user.

32. The device of claim 29, wherein the first functional units is a generic functional unit and the second functional unit is a non-generic functional unit.

33. The device of claim 32, wherein the generic functional unit includes a mass storage unit.

34. The device of claim 33, wherein the mass storage unit includes an installer application operable to install on the host system a device driver for the non-generic functional unit of the peripheral device.

35. The device of claim 29, wherein the memory further includes a thin driver operable to locate a device driver for the one of the first and second functional units.

36. The device of claim 35, wherein the location of the device driver includes one of the memory of the host system, memory of the peripheral device, installation CD and a network server.

37. The device of claim 29, wherein the host interface includes one of a wired interface and wireless interface.

38. The device of claim 29, wherein the multifunctional peripheral device is embedded in the host system.
